(19) United States
(12) Patent Application Publication
(10) Pub. No.: US 2006/0228458 A1
(43) Pub. Date: Oct. 12, 2006

(54) Method for processing fruits and vegetables on the base of lecithin

(76) Inventor: Alberto Sardo, Chateaurenard (FR)

Correspondence Address: WENDEROTH, LIND & PONACK, L.L.P., 2033 K STREET N. W., SUITE 800, WASHINGTON, DC, 20006-1021, US

(21) Appl. No.: 10/552,460

(22) PCT Filed: Mar. 24, 2004
(86) PCT No.: PCT/FR04/00734

§ 371 Date: Oct. 7, 2005

(30) Foreign Application Priority Data
Apr. 8, 2003 (FR) 0304350
Jul. 15, 2003 (FR) 0308628

(51) Int. Cl. A23D 9/00

(52) U.S. Cl. 426/601

(57) ABSTRACT

The invention relates to the use of lecithins for processing fruits and vegetables and to the compound containing said lecithins.

The present invention relates to the use of one or more lecithins and/or derivatives for treating fruit and vegetables and the new compositions comprising one or more lecithins together with one or more treatment agents for fruit and vegetables, in particular terpene(s) having a hydroxyl function and having antioxidant, bactericidal and/or fungicidal properties.

Before harvesting, fruit and vegetables are treated with various agents, such as fertilisers or insecticides in order to promote their growth.

After they have been harvested, the fresh fruit and vegetables are stored for a period of time, which may be relatively long, before being marketed for rapid consumption.

During this storage period, it is important for the fruit and vegetables not to lose their organoleptic properties or their attractive appearance. It is therefore desirable to delay the ageing process of the fruit and vegetables during the storage period.

In order to delay such a degradation of the fruit and vegetables to the greatest possible extent, it is known to treat them, just after harvesting, using physical treatments, such as heat (for example, thermotherapy), or cold (for example, isocooling or refrigeration), and/or using chemical treatments by means of antioxidant, bactericidal and/or fungicidal substances. The most commonly used antioxidant, bactericidal and/or fungicidal substances are synthetic products which have a given level of toxicity for the consumer: this is in particular the case for diphenylamine, orthophenylphenol, marketed by BASF, imazalil (1-(2-(2,4-dichlorophenyl)-2-(2-propenyloxy)ethyl)-1H-imidazol), which is commercially available, for example, from Janssen Pharmaceutica or Inchem, or ethoxyquine (1,2-dihydro-6-ethoxy-2,2,4-trimethylquinoline), marketed, for example, by Raschig.

A method is known for treating fruit and vegetables by means of application of dioxygen terpenes, such as, eugenol or isoeugenol, this method being described in FR 98 15 305. These compounds protect the fruit and vegetables against bacteria and fungi and prevent potato tubers and onion bulbs from germinating.

However, the physical and/or chemical treatments for fruit and vegetables as indicated above are phytotoxic with regard to the fruit and vegetables treated.

According to the invention, “phytotoxicity” is understood to be any impairment of the fruit and vegetables resulting from the direct action of the physical and/or chemical treatment, which can be seen in the modification of the visual appearance of the fruit and vegetables or their leaves.

According to the invention, “phytotoxicity” preferably refers to the direct alteration by the treatment of the integrity of the skin of the fruit and vegetables, in particular by the modification of the colour or texture of the skin thereof. More particularly, the phytotoxicity may become evident as a homogeneous yellowish colouring, a red pigmentation, the formation of yellow or brown blemishes, or local or extended regions of necrosis, or the formation of microlesions on the skin.

These microlesions constitute an environment which promotes occurrences of mould or decay on the fruit and vegetables.

According to the invention, the phytotoxicity defined above results directly from the action of the treatment and consequently excludes natural phenomena of ageing, such as senescence in particular.

Owing to this phytotoxicity, the treatments for fruit and vegetables therefore have a contradictory action which limits the use thereof.

Lecithins are mixtures of combinations of oleic, stearic, and palmitic acid esters with glycerophosphoric acid and choline.

Lecithins are commonly used surfactant and emulsifying agents of natural origin. Lecithins are widely used as food, pharmaceutical or cosmetic additives.

It has unexpectedly now been discovered according to the present invention that lecithins or derivatives thereof limit the phytotoxic effect of the physical and/or chemical treatments for fruit and vegetables, in particular the treatment agents such as eugenol or isoeugenol.

Specifically, the use of lecithins or derivatives according to the invention has a phytoprotective effect by delaying or preventing the formation of blemishes or microlesions which are brought about by the physical and/or chemical treatments, in particular the treatment agents such as eugenol or isoeugenol.

According to a first aspect, the present invention therefore relates to the use of lecithins and/or derivatives thereof in order to limit the phytotoxicity of the physical and/or chemical treatments for fruit and vegetables, in particular the treatment agents such as hydroxyl-function terpenes.

According to a second aspect, the present invention relates to the compositions which comprise the combination of one or more treatment agents for fruit and vegetables, such as hydroxyl-function terpenes which have antioxidant, bactericidal and/or fungicidal properties, with lecithins and/or derivatives thereof.

According to another aspect, the present invention also relates to the use of the compositions according to the invention for treating fruit and vegetables.

The inventors have also found that the preservation of the lecithins and/or derivatives according to the invention was significantly improved by the presence of one or more treatment agents according to the invention, in particular the agents having bactericidal, fungicidal or antioxidant properties, such as eugenol. In this case, the treatment agent(s) represent(s) from 1 to 50%, preferably from 10 to 30% by weight of the lecithins and/or derivatives.

According to another aspect, therefore, the invention also relates to the use of one or more treatment agents in order to improve the preservation of the lecithins and/or derivatives.

“Physical and/or chemical treatment of fruit and vegetables” is understood to be any type of treatment which is conventionally used to improve the growth and/or preservation of the fruit and vegetables before and/or after harvesting and which generally has a phytotoxic effect on them.

As set out above, phytotoxicity does not include natural senescence; consequently, the physical and/or chemical treatments which bring about an ageing effect, in particular by increasing the respiration by releasing ethylene, such as ethephon, are not included in the invention.

It is understood that the chemical treatments may be used in combination with the physical treatments.

The physical treatments include in particular heat treatment, for example, from 20 to 60° C., such as thermotherapy, for example, using warm water, or cold treatment, for example, from 0 to 20° C., such as isocooling or refrigeration, using cold air. The chemical treatments designate all the treatment agents conventionally used for these purposes. These include in particular fertilisers, insecticides, fungicides, bactericides, antioxidants or preservatives.

As a treatment agent used prior to harvesting, it is possible to mention in particular the products used in orchards, such as foliar fertilisers based on calcium chloride, such as Stopit, marketed by Phosyne plc, tolyfluanid which is available under the name of Methyleuparen®, marketed by Bayer, or any other speciality which is used in orchards, such as, for example, the mineral oils which are conventionally used, optionally combined with one or more phytosanitary products which are known per se.

As post-harvest treatment agents, it is possible to mention various products, such as diphenylamine, orthophenylphenol, marketed by BASF, imazalil (1-(2-(2,4-dichlorophenyl)-2-(2-propenyloxy)ethyl)-1H-imidazol), which are commercially available, for example, from Janssen Pharmaceutica or Inchem, or ethoxyquine (1,2-dihydro-6-ethoxy-2,2,4-trimethylquinoline), marketed, for example, by Raschig.

Preferred treatment agents also include derivatives of natural origin, such as hydroxyl-function terpenes which have antioxidant, bactericidal and/or fungicidal functions.

“Hydroxyl-function terpene” is intended according to the invention to refer to terpenes which have at least one hydroxyl function, optionally a phenol function. The hydroxyl-function terpene will also be designated below by the term “terpenic active ingredient”. The terpenes which can be used according to the invention preferably contain from 1 to 5, more preferably, 1, 2 or 3 hydroxyl functions.

Preferably, the terpenes used have a vapour pressure of at least 0.1 mm of mercury, more preferably between 0.1 mm and 5 mm of mercury.

Examples of terpenes include farnesol, menthol, linalool, p-menthan-1,8-diol, terpineol, citronellol, geraniol, eugenol, isoeugenol, one of the salts thereof which are acceptable in foodstuffs and mixtures thereof.

As a particularly preferred terpene, it is possible to mention eugenol, isoeugenol, the salts thereof which are acceptable in foodstuffs and mixtures thereof.

It should be understood that, according to a more particularly preferred embodiment, oil of cloves is used as an active ingredient, containing from 60% to 75% of eugenol.

According to a preferred embodiment, the compositions according to the invention contain one or more treatment agents as defined above.

In some cases, the terpenes may be applied either as pure products or in the form of natural oils containing between 50% and 80% of terpenes.

According to the invention, the expression “lecithins and/or derivatives” is intended to refer to one or more compounds selected from the derivatives of phosphatidylcholine and/or the derivatives thereof, such as phosphatidylcholine, phosphatidylinositol, phosphatidylethanolamine and/or phosphatidic acid and/or the mixtures thereof which have two fatty acids, such as distearyl, dipalmityl and/or dioleyl of phosphatidylcholine, phosphatidylinositol, phosphatidylethanolamine and/or phosphatidic acid, and/or the mixtures thereof.

Preferably, the “lecithins and/or derivatives” are of natural origin, such as, for example, from egg yolk or soya.

The inventors have also found that the “lysolecithins and/or derivatives” are more soluble when they are formulated, alone or in admixture, in the compositions according to the invention.

According to a preferred aspect, the “lecithins and/or derivatives” therefore contain one or more “lysolecithins and/or derivatives”.

“Lysolecithins and/or derivatives” are intended to refer to the compounds resulting from the removal of a fatty acid from the “lecithins and/or derivatives” mentioned above. They therefore include in particular the derivatives lysophosphatidylcholine, lysophosphatidylinositol, lysophosphatidylethanolamine and/or lysophosphatidic acid and/or the mixtures thereof. Generally, when they are used as additives, such as, for example, emulsifying or surfactant agents, lecithins are generally present at low concentrations, such as between 1% and 5%.

It has now been shown by the inventors that, against all expectations, the “lecithins and/or derivatives” could be used at higher concentrations greater than or equal to 10% in order to achieve the desired phytoprotective effect. More preferably, the lecithins have a concentration which is strictly greater than 5%. Preferably, the concentration of lecithins and/or derivatives in the compositions is between more than 5% and 50%.

According to the invention, the lecithins and/or derivatives and the treatment agents may be applied simultaneously, separately or staggered over time. The lecithins and/or derivatives can therefore be formulated alone or in admixture with one or more treatment agents in the compositions according to the invention.

In particular, the ratio of “lecithins and/or derivatives” to the treatment agent, preferably a terpenic active ingredient, may be from 0.3 to 3, preferably from 0.5 to 1.5.

According to a preferred aspect, the “lecithins and/or derivatives” according to the invention include lecithins E322 or lecithins derived from soya oil.

According to a particularly preferred aspect in accordance with the invention, the “lecithins and/or derivatives” contain at least one or more “lysolecithins and/or derivatives”. Generally, the “lecithins and/or derivatives” are selected from the distearyl, dipalmityl and/or dioleyl compounds of phosphatidylcholine, phosphatidylinositol and/or phosphatidylethanolamine, phosphatidic acid and the corresponding lyso compounds and/or the mixtures thereof.

Advantageously, the “lecithins and/or derivatives” contain between 30% and 60% of “lysolecithins and/or derivatives”. In particular, the modified and non-modified mixtures of lecithins derived from soya oil are preferred.

The “lecithins and/or derivatives” are preferably obtained by means of extraction from vegetable oil, followed by the removal of the oil and at least partial hydrolysis of the fatty acid groups.

According to one advantageous aspect, Emultop HL50® marketed by Degussa is used as the “lecithins and/or derivatives”.

Since the “lecithins and/or derivatives” which contain at least one “lysolecithin and/or derivative” according to the invention are soluble in vegetable-based oils, the compositions according to the invention therefore allow products of natural origin only to be used. The use of organic solvents or other synthetic additives which are conventionally used to improve the solubility or the stabilisation of the compositions is therefore superfluous. This therefore ensures the absence of toxicity for the consumer. This also allows the compositions to be sold marked as biological.

The compositions according to the invention can be diluted in an aqueous or organic base or a mixture thereof.

As an organic base, it is in particular possible to use any oil which is acceptable in foodstuffs, such as, in particular vegetable oils, soya or peanut oil.

Generally, the lecithins and/or derivatives may be formulated alone or in water or in a vegetable oil, optionally with non-ionic synthetic emulsifying agents or dispersants of the ethoxyl oleic acid type, for example.

Preferably, when lecithins and/or natural derivatives are used, they are formulated with or without vegetable oil and dispersants such as those indicated above.

When lecithins and/or derivatives are used which contain one or more lysolecithins and/or derivatives, they may further be formulated in solution in a vegetable oil with no emulsifying agent.

When EMULTOP HL50® is used, it is possible to formulate the lecithins and/or derivatives alone, dispersed in water, preferably up to a maximum of 20%.

Preferably, the lecithins and/or derivatives which are alone or in admixture with the treatment agents in the compositions according to the invention are applied to the fruit and vegetables at concentrations of between 10 and 5000 ppm, preferably between 100 and 500 ppm.

To this end, the formulations of lecithins and/or derivatives may be diluted in an aqueous dispersion. Preferably, the application dose is between 1 and 50 litres/tonne of aqueous dispersion for a post-harvest treatment and between 100 and 2000 litres per hectare prior to harvesting.

The lecithins and/or derivatives may be applied to the fruit and vegetables by any means known per se, for example, by means of spraying in the orchard before harvesting or showering or immersion after harvesting.

The compositions according to the invention contain between 5% and 70% by weight of treatment agent, preferably a terpenic active ingredient, preferably between 10% and 30%, even more preferably between 15% and 20%; between 1% and 50% by weight of “lecithins and/or derivatives” according to the invention, preferably between 10% and 40%, even more preferably between 10% and 30%; and between 10% and 70% of aqueous or organic base, which is preferably organic, and preferably between 30% and 60%.

More preferably, the compositions contain eugenol with strictly more than 5% of lecithins.

The percentages indicated above and below are understood to be by weight relative to the active ingredients. Since the active ingredients are commercially available in diluted liquid or solid form, the quantities of these diluted forms must consequently be increased.

For example, the lecithins and/or derivatives” may be in diluted form in a powder which contains between 40% and 75% of lecithins or derivatives. The percentages indicated should be understood in relation to the non-diluted “lecithins and/or derivatives”.

According to a preferred embodiment, the compositions according to the invention comprise a combination of eugenol or isoeugenol, preferably eugenol, with a mixture of lecithins or derivatives which contains one or more “lysolecithins and/or derivatives” in admixture in a vegetable oil.

Generally, the compositions according to the invention contain from 10% to 30% of eugenol, from 10% to 40% of “lecithins and/or derivatives” containing one or more “lysolecithins and/or derivatives”, from 30% to 60% of vegetable oil.

Advantageously, the “lecithins and/or derivatives” contain between 30% and 60% of “lysolecithins and/or derivatives”.

Preferably, the compositions according to the invention contain between 10% and 40% of Emultop HL50®, more preferably between 20% and 30%.

The compositions according to the invention contain between 5% and 15% of “lysolecithins and/or derivatives”.

Advantageously, non-modified “lecithins and/or derivatives” are used, each in admixture with the corresponding modified form thereof.

Generally, the mixture of each non-modified “lecithin and/or derivative” with the modified form thereof is between 0.3% and 10% of the compositions according to the invention.

The compositions are prepared by mixing the lecithins or derivatives in vegetable oil, preferably at ambient temperature, then adding the treatment agent(s) with agitation. If necessary, the compositions obtained are left to rest for a period of time of from a few hours to several days before use.

The formulation of the treatment composition depends on its method of application to the fruit and vegetables.

The compositions are preferably diluted in water at a concentration of between 1 and 20 l per m³ of water, prior to treatment of the fruit and vegetables.

The treatment compositions are prepared in a manner which is conventional per se by simply mixing the constituents thereof.

The compositions according to the invention must be applied once or several times. According to one advantageous aspect, a single treatment is carried out.

The treatment is preferably carried out as soon as possible after harvesting.

The quantity of treatment composition which has to be applied to the fruit and vegetables depends on the type of fruit and vegetables concerned and the method of application selected. Generally, the consumption of diluted solution is between 1 and 50 litres, preferably between 5 and 20 litres per tonne of fruit treated, preferably approximately 10 litres per tonne of fruit or vegetables treated.

The method for applying the lecithins and/or derivatives alone or in admixture with the treatment agent(s) in the compositions according to the invention may be selected as desired in accordance with the invention. Emphasis is more particularly placed on application by means of spraying, in particular before harvesting, or by means of immersion, by means of showering, by means of sprinkling, or by means of coating using an absorbent paper which is soaked in treatment composition, in particular after harvesting. Application by means of immersion, showering or sprinkling is preferred after harvesting. Preferably, when the application is carried out after harvesting, it is carried out at a temperature of between 15° C. and 60° C., preferably between 30° C. and 60° C. using the methods described below.

In a variant, the application may be carried out by means of immersion or showering by implementing the step which consists in:

bringing the treatment composition to a temperature of from 15 to 60° C., preferably from 30° to 60° C.; and

subjecting the fruit and vegetables to a treatment for a maximum of 10 minutes by means of showering with the treatment composition or by means of immersion in the treatment composition before the fruit and vegetables are stored.

Generally, the fruit and vegetables are showered on a bench. In the case of fruit and vegetables which are particularly sensitive to impacts, it is preferable to immerse the fruit and vegetables into the treatment compositions in a case.

The temperature to which the treatment composition is heated is adjusted in accordance with the type of product treated. It is important not to bring about the cooking or degradation of the fruit and vegetables. Only the surface of the fruit and vegetables must be heated by being placed in contact with the treatment composition.

Generally, the treatment composition is brought to a temperature of from 15° to 60° C., preferably 30° to 60° C., in accordance with the type of fruit and vegetables treated, and the contact time is adjusted in a parallel manner in order to reach the desired temperature at the surface of the fruit and vegetables.

Generally, the operation is carried out at from 45° to 50° C. However, for fruit and vegetables which are sensitive to heat, such as lemons, for example, temperatures of from 30° to 40° C. are preferred.

The contact time is very short and in any case less than 10 minutes. It is generally from 30 seconds to 10 minutes, advantageously from 30 seconds to 5 minutes. A contact time of from 2 to 3 minutes is most often sufficient.

When the length of treatment time with the hot composition is reached, the application is brought to an end by any known means, in particular by simply stopping the sprinkling or showering.

In one advantageous variant, in particular in the case of fruit and vegetables which are sensitive to heat, the method may comprise a subsequent step which consists in rapidly cooling the fruit and vegetables which have been brought into contact with the hot treatment composition, up to a temperature less than or equal to ambient temperature.

This cooling may be carried out by means of circulation of air or by contact with water (in particular immersion or sprinkling) whose temperature is less than or equal to ambient temperature.

In the case of fruit and vegetables which are particularly sensitive to heat, such as peaches, apricots, tomatoes and pears, it is recommended to cool them in advance before carrying out the heat treatment using the treatment composition.

In this manner, according to a preferred embodiment of the invention, the immersion or showering step described above is preceded by a step for core cooling by means of showering with an aqueous cooling composition or by means of immersion in an aqueous cooling composition, the aqueous cooling composition having a temperature of between 0° and 15° C.

The cooling must take effect at the actual core of the fruit and vegetables. The fruit and vegetables are, for example, subjected to a treatment by means of hydrocooling. This may be carried out by means of showering with an aqueous cooling composition or by means of immersion in an aqueous cooling composition.

The temperature of the aqueous cooling composition is generally between 0° and 15° C.

The temperature and the time for pre-treatment with the cooling composition are adjusted so as to cool the whole of the fruit or vegetables treated and not only the outer layer thereof. These parameters depend principally on the type of fruit and vegetables. By way of indication, it should be noted that the temperature of the cooling composition is less than or equal to the conventional storage temperature recommended in the art.

According to a preferred embodiment, the aqueous cooling composition has a temperature of from 0° to 10° C., more preferably from 0° to 5-6° C. The duration of pre-treatment with the aqueous cooling composition is generally between 2 minutes and 2 hours, most often between 2 minutes and 60 minutes, for example, between 4 minutes and 30 minutes.

This variant is more particularly described in applications FR 96 03 100 and FR 98 09 995.

In one variant and according to a preferred embodiment of the invention, the treatment composition used for application by means of showering or immersion is a dispersion of the composition in water.

When an absorbent paper is used, a quantity of from 0.01 g to 1 g of active ingredient per m² of paper is generally sufficient, given that a m of paper allows 16 to 25 pieces of fruit to be coated.

More generally, the quantity of active ingredient depends on the volatility (and therefore the vapour pressure) of the treatment agent(s) used as an active ingredient and the length of time in storage.

Of course, the preferred embodiments indicated above or below should be understood to be taken in isolation or combination.

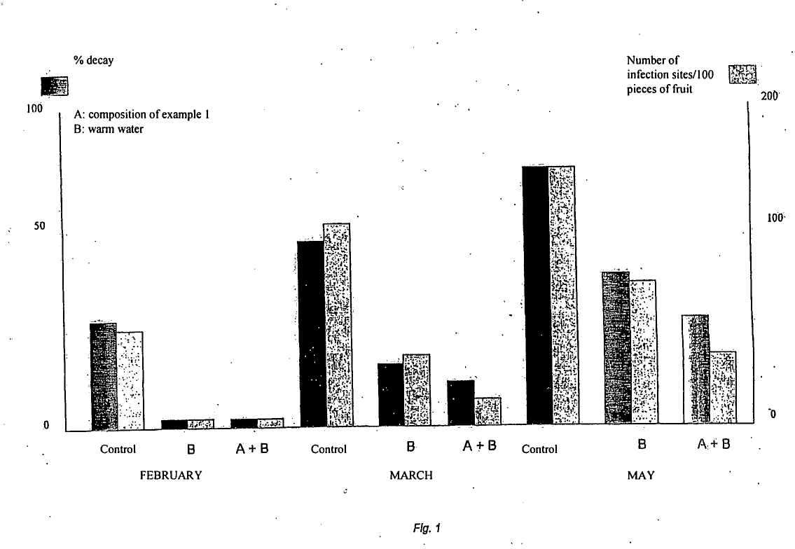

The invention is in particular illustrated by the examples and FIG. 1 below.

FIG. 1 illustrates the effect of the compositions according to the invention on the occurrences of decay in apples.

### EXAMPLES 1

A composition according to the invention was prepared in the following manner:

27 g of a mixture of lecithins and/or derivatives containing between approximately 40% and 75% of lecithins or derivatives, including approximately 50% of lysolecithins or derivatives (Emultop HL50®), are dissolved in 55 g of vegetable oil (soya) at ambient temperature. 18 g ml of eugenol are then added at ambient temperature with constant agitation. 100 g of reconstituted oil solution is thus obtained.

The solution obtained is completely clear. It contains 18% of eugenol, 27% of Emultop HL50®, that is to say, approximately from 10% to 20% of lecithins or derivatives and 55% of vegetable oil.

### EXAMPLE 2

The procedure of example 1 is repeated but this time using non-modified lecithins and/or derivatives. A suspension is obtained. The eugenol is added in an identical manner. The solution is cloudy. From 10% to 30% of dispersant agent of the anionic, cationic, or non-ionic type is required to improve the homogeneity of the dispersion of the composition in water.

### EXAMPLE 3

### Treatment of Granny Smith Apples

A first batch of Granny Smith apples was treated after harvesting by means of immersion or showering using a treatment composition according to example 1, diluted in water at 50° C., at a ratio of 2 g/l expressed in terms of eugenol, that is to say, 11 g/l of 18% eugenol composition.

After treatment, this batch was stored at 0.5° C. for three months in a refrigerator with a modified atmosphere having 2% of oxygen and 2.5% of carbon dioxide (CO₂).

Two control batches were subjected to the same storage conditions as the previous batch without the apples being treated (control) or only being treated with water.

The application is carried out for 3 minutes.

The results summarised in FIG. 1 indicate that the compositions of the invention reduce by more than 50% the occurrences of decay appearing on the pieces of fruit two to four months following application.

### EXAMPLE 4

### Comparative

Oranges of the Washington Navel variety were treated with various doses of eugenol only at different temperatures.

After 15 days at approximately 50° C., followed by 3 days at ambient temperature, the pieces of fruit affected by penicillium mould were counted.

The results are summarised in the following table.

TABLE 1

| | % of fruit having |
|---|---|
| | penicillium mould |
| Control (cold water) | 8 |
| Warm water (36° C.) | 8 |
| Warm water (50° C.) | 3 |
| Eugenol 9000 ppm (solution at 30 g/l) 50° C. | 29 |
| Eugenol 5000 ppm (solution at 17 g/l) 36° C. | 13 |
| Eugenol 5000 ppm (solution at 17 g/l) 46.5° C. | 22 |

The results indicate that the treatment using eugenol only promotes occurrences of decay.

### EXAMPLE 5

Example 4 was repeated with the composition of example 1. The percentage of pieces of fruit treated with this composition which have penicillium mould is 4%.

When the results of examples 4 and 5 are viewed, it can be concluded that eugenol brings about microlesions which provide an environment which promotes attack by penicillium; this phytotoxicity of eugenol is practically eliminated when eugenol is used in combination with lecithins according to the invention.

### EXAMPLE 6

100 apples of the Golden variety were treated with or without the lecithins of example 1 at a concentration of 2000 ppm at 50° C. before storage, then stored in a cooled chamber for 7 months at 0.5° C.

The apples which were not treated had a yellow coloration whilst this change in colour did not appear on the apples which were treated.

### EXAMPLE 7

Valencia Late oranges are treated with or without the lecithins of example 1 at a concentration of 2000 ppm and stored for 3 months at 3.5° C.

The oranges which were not treated show occurrences of damage linked to the cold (“chilling injuries”) which are not visible for the treated apples.

1. Use of lecithins and/or derivatives in order to reduce the phytotoxicity of the physical and/or chemical treatments for fruit and vegetables.

2. Use according to claim 1, such that the chemical treatments consist of treatment agents.

3. Use according to claim 1 or 2, such that the physical treatments are carried out by means of heat or cold.

4. Use according to any one of the preceding claims, such that the lecithins and/or derivatives contain one or more lysolecithins and/or derivatives.

5. Use according to any one of the preceding claims, such that the lecithins and/or derivatives contain between 30% and 60% of lysolecithins and/or derivatives.

6. Use according to any one of the preceding claims, such that the lecithins and/or derivatives are selected from the distearyl, dipalmityl or dioleyl compounds of phosphatidylcholine, phosphatidylinositol, phosphatidylethanolamine or phosphatic acid and optionally the corresponding lyso derivatives or the mixtures thereof

7. Use according to claim 6, such that the lecithins and/or derivatives and the treatment(s) are applied simultaneously, separately or staggered over time.

8. Use according to any one of the preceding claims, such that the lecithins and/or derivatives are formulated in an aqueous solution or in a vegetable oil, then diluted in an aqueous dispersion before treatment.

9. Use according to any one of the preceding claims, such that the lecithins and/or derivatives are applied to the fruit and vegetables at a dose of between 10 and 5000 ppm.

10. Use according to any one of claims 2 to 9, such that the treatment agents are selected from fertilisers, insecticides, fungicides, bactericides, antioxidants or preservatives.

11. Use according to any one of claims 2 to 10, such that the treatment agents are selected from the foliar fertilisers based on calcium chloride, tolyfluanid, diphenylamine, orthophenylphenol, imazalil, ethoxyquine, hydroxyl-function terpenes having antioxidant and/or fungicidal functions.

12. Use according to any one of claims 2 to 11, such that the treatment agents are as defined in claims 15 to 17.

13. Compositions containing one or more treatment agents for fruit and vegetables and one or more lecithins and/or derivatives.

14. Compositions according to claim 13, such that the treatment agents and lecithins are formulated in order to be administered simultaneously, separately or staggered over time.

15. Compositions according to claim 13 or 14, such that the treatment agents are hydroxyl-function terpenes having antioxidant and/or fungicidal functions.

16. Compositions according to any one of claims 13 to 15, such that the hydroxyl-function terpenes are selected from eugenol, isoeugenol, farnesol, menthol, linalool, p-menthan-1,8-diol, terpineol, citronellol, geraniol, one of the salts thereof which are acceptable in foodstuffs or mixtures thereof.

17. Compositions according to any one of claims 13 to 16, such that the hydroxyl-function terpenes are selected from eugenol, isoeugenol, the salts thereof which are acceptable in foodstuffs or mixtures thereof.

18. Compositions according to any one of claims 13 to 17, dissolved in an oil base.

19. Compositions according to claim 18, such that the oil base is a vegetable oil.

20. Compositions according to any one of claims 13 to 19, such that they contain between 5% and 70% of treatment agents, 1% and 50% of lecithins and/or derivatives, 10% and 70% of oil base.

21. Compositions according to any one of claims 13 to 20, containing from 10% to 30% of eugenol, from 10% to 40% of lecithins and/or derivatives, from 30% to 60% of vegetable oil.

22. Compositions according to claim 21, characterised in that they contain between 5% and 15% of lysolecithins and/or derivatives.

23. Compositions according to any one of claims 13 to 22, characterised in that the ratio of lecithins and/or derivatives relative to the treatment agent is from 0.3 to 3.

24. Compositions according to claim 23, characterised in that the ratio is from 0.5 to 1.5.

25. Compositions according to any one of claims 13 to 24, such that the lecithins and/or derivatives are as defined in any one of claims 1 to 12.

26. Use of a composition according to any one of claims 13 to 25 for treating fruit and vegetables.

27. Method for treating fruit and vegetables comprising the application to the fruit and vegetables of a composition according to any one of claims 13 to 25.

28. Method according to claim 27, characterised in that the composition is diluted in water at a ratio of from 1 to 20 l/m³ of water.

29. Method according to claim 27 or claim 28, such that the composition is diluted beforehand in water and applied at a temperature of from 30° to 60° C.

30. Method according to any one of claims 27 to 29, comprising the application of the composition by means of immersion, showering, sprinkling or coating using an absorbent paper.

31. Method according to any one of claims 27 to 30 for which the application of the composition is carried out after harvesting.

32. Method according to claim 27 or 28 for which the application of the composition is carried out before harvesting by means of spraying.

33. Method for treating fruit and vegetables comprising the application to the fruit and vegetables of lecithins and/or derivatives as defined according to any one of claims 3 to 12, before, after, or at the same time as the physical treatment.

34. Method for preparing a composition according to any one of claims 13 to 25, comprising the addition of the lecithins or derivatives to the oil base followed by the addition of the treatment agent(s).

35. Use of one or more treatment agents as a preservative for the lecithins and/or derivatives, as defined according to any one of claims 1 to 12.

36. Use according to claim 35, such that the treatment agent has antioxidant, fungicidal or bactericidal properties.

37. Use according to claim 35 or 36, for which the treatment agent is eugenol.

38. Use according to any one of claims 35 to 37, for which the treatment agent represents from 1 to 50% by weight of the lecithins and/or derivatives.
